(19) United States
(12) Patent Application Publication
(10) Pub. No.: US 2006/0174310 A1
(43) Pub. Date: Aug. 3, 2006

(54) Extended metadata and adaptive program service providing system and method for providing digital broadcast program service

(76) Inventors: Hee-Kyung Lee, Daejon (KR); Han-Kyu Lee, Daejon (KR); Kyeong-Ok Kang, Daejon (KR); Jin-Woong Kim, Daejon (KR)

Correspondence Address: LADAS & PARRY LLP, 224 SOUTH MICHIGAN AVENUE, SUITE 1600, CHICAGO, IL, 60604, US

(21) Appl. No.: 10/547,985

(22) PCT Filed: Mar. 13, 2004
(86) PCT No.: PCT/KR04/00532

§ 371 Date: Sep. 8, 2005

(30) Foreign Application Priority Data
Mar. 13, 2003 (KR) 10-2003-0015651

(51) Int. Cl. G06F 3/00; H04N 7/16; G06F 13/00; H04N 5/445

(52) U.S. Cl. 725/135; 725/136; 725/40

(57) ABSTRACT

The present invention relates to extend metadata for providing a digital broadcast program service to diverse kinds of terminals, and a system and method for providing an adaptive program service to the terminals by using the extended metadata. The system and method performs integrated management of resource information suitable for a combination of all (terminal, program and user) conditions of the personal terminal, manages resource-related information separately from temporal/spatial location information, and thus provides an adaptive program service by using extended metadata and recomposing an adaptive scene for a personal terminal so as to provide the digital broadcast service adaptively to diverse terminal environments on a home network. The extended metadata include: segmentation metadata including description information on a significant segment that forms the broadcast program; and resource description metadata including description information on lower composition resources of the segment in order to provide a broadcast program to the diverse kinds of terminals.

### TECHNICAL FIELD

The present invention relates to a data structure of metadata used to provide a digital broadcasting service, a system and method for providing a program service by using the metadata of the data structure, and a computer-readable recording medium for recording a program that implements the method. More particularly, the present invention relates to a data structure of extended metadata, a system and method for providing a program service adaptively by using the metadata of the data structure, in which a high resolution/high-volume digital broadcast program can be provided by a broadcast program service provider adaptively to diverse kinds of personal terminals by using the extended metadata, and a computer-readable recording medium for recording a program that implements the method.

### BACKGROUND ART

Generally, users consume broadcast programs or contents that are provided one-sidedly by a program service provider according to a schedule of the program service provider.

This method of providing broadcast programs or contents can hardly accommodate diverse requests from users. Most users want to watch various sorts of programs in a method they want at a time they prefer.

Generally, a program means a group of a series of contents. In the present specification, it is defined that a program is a group of a series of contents acquired as one unit in a personal digital recorder (PDR), for example, 90'clock Newsdesk broadcasted by a broadcasting station MBC.

In order to satisfy the needs of the users, “TV-Anytime” Forum defines and provides a standard for a metadata structure that allows all users to watch diverse kinds of programs in a method and time they want based on the PDR.

The “TV-Anytime” Forum is a private standardization organization established in September 1999 to develop standards for providing audio and video-related services in a user environment having a PDR.

Also, the metadata stand for descriptive data that describe the title of a program, genre, overview and the like. Generally, the metadata are defined as data about data.

Hereinafter, the metadata having a metadata structure provided by the “TV-Anytime” Forum are referred to as conventional metadata.

FIG. 1 is a diagram showing a structure of conventional metadata. As shown, the conventional metadata include content description metadata 110, instance description metadata 120 and segmentation metadata 130. The content description metadata 110 describe general information of a program that is independent from the location of the program, i.e., location-independent general information of a program. The instance description metadata 120 describe information on a program entity that is actually broadcasted. The segmentation metadata 130 describe information on a significant segment of a program.

Here, a segment means a unit that forms one content included in the program consecutively, for example, a thing such as news topic that constitutes one news program.

The content description metadata 110 are formed of program metadata 111 and program group metadata 112. The program metadata 111 describe information for the location-independent general information of a broadcast program, such as the title of a program, genre, storyline and character introduction. The program group metadata 112 describe information on a group of programs.

The instance description metadata 120 include a program location metadata 121 that describe information on the location and service information of a program related to a particular broadcast event.

The segmentation metadata 130 are formed of segment metadata 131 and segment group metadata 132. The segment metadata 131 divide a program into segments, recompose the program in various ways, and provide description information on the content such as highlight, bookmark and event-based browsing. The segment group metadata 132 describe information on a set of segments.

The structure of the conventional metadata considers a conventional user environment, i.e., a single terminal environment which includes a settop box. In this environment, considered only is to provide a program and metadata that conform to the conditions of the settop box, such as a CPU processing rate, an aspect ratio of a screen, and the capacity of a storage.

However, the user environment is changing from the conventional single terminal environment to a terminal environment where a plurality of diverse terminals, e.g., laptop computers, Personal Digital Assistants (PDA), MP3 players, home theaters, Digital Video Disk (DVD) players, game consoles and digital cameras, are connected to a wired/wireless home network.

Therefore, with the digital broadcasting service using the conventional metadata, it is impossible to accommodate the diverse requests for broadcast programs and metadata provided adaptively to the conditions of each terminal in response to the change in user environment.

For example, for a PDA with a tiny screen, video provided from a settop box should be curtailed to fit into the screen. In case of an MP3 player that cannot process video, only audio should be extracted from a video program and provided.

The goal of providing programs and metadata adapted to the diverse terminal cannot be achieved by such an inactive way that the volume of a program is reduced simply by transforming the program or dropping redundant data.

Required, therefore, is an active method for recomposing a scene that consumes a program and metadata adaptively to the utility conditions of diverse terminals.

Also, according to conventional scene describing languages for describing the recomposed scene to a user terminal, such as Synchronized Multimedia Integration Language (SMIL) and Extensible MPEG-4 Textual Format (XMT), information related to resources for composing a scene is managed along with information on the temporal/spatial location and interaction of resources on the scene.

The managing method, however, has a problem that it is hard to re-use the resource-related information which is used repeatedly to provide a plurality of scenes for diverse terminals.

Here, a resource signifies an audio visual (AV) object forming one segment, for example, video, audio, image and text.

Also, to select resources for composing a scene, each personal program service provider manages combinations of utility conditions (terminal, program and user) of a certain terminal and the resource information corresponding to each combination independently. Since this method stores the same information doubly, the storing device is used wastefully.

Therefore, to provide a digital broadcasting service adaptively to diverse terminal environments constituting a home network, required is a method for recomposing a scene adaptively to each terminal, the method that can integrate and manage the combinations of all utility conditions (terminal, program and user) of the diverse terminals and the resource information for each combination, and manage the resource-related information separately from the temporal/spatial location information.

### DISCLOSURE OF INVENTION

It is, therefore, an object of the present invention to provide a data structure of extended metadata that can recompose a scene adaptively to each terminal by integrating and managing combinations of diverse personal terminal conditions and resource information for each combination, and providing resource related information separately from temporal/spatial location information in order to provide a digital broadcasting service adaptively to diverse terminal environments that constitute a home network.

It is another object of the present invention to provide a system and method for providing a program service adaptively by using the extended metadata to provide a digital broadcasting service adaptively to diverse terminal environments that constitute a home network.

It is another object of the present invention to provide a computer-readable recording medium for recording a program that implements a method for providing a program service adaptively by using the extended metadata to provide a digital broadcasting service adaptively to diverse terminal environments that constitute a home network.

In accordance with one aspect of the present invention, there is provided extended metadata for providing a digital broadcast program service to diverse kinds of terminals, including: segmentation metadata including description information on a significant segment that forms the broadcast program; and resource description metadata including description information on lower composition resources of the segment in order to provide a broadcast program to the diverse kinds of terminals.

In accordance with another aspect of the present invention, there is provided a system for providing an adaptive program service by using extended metadata to provide a digital broadcast program service to diverse kinds of terminals, including: a broadcast program service providing unit for providing the program and the extended metadata; a personal program service providing unit for storing the program and the extended metadata transmitted from the broadcast program service providing unit, and providing an adaptive broadcast program that conforms to utility conditions of a terminal by using resources corresponding to terminal conditions;. and a personal terminal controlling/playing unit for transmitting the terminal conditions and user conditions to the personal program service providing unit and receiving the adaptive program from the personal program service providing unit.

In accordance with another aspect of the present invention, there is provided an apparatus for providing a broadcast program service by using extended metadata in a system for providing a digital broadcast program to diverse kinds of terminals, including: a broadcast program providing unit for providing the program and the extended metadata.

In accordance with another aspect of the present invention, there is provided a personal program service providing apparatus for providing an adaptive program by using extended metadata in a system for providing a digital broadcast program service to diverse kinds of terminals, including: a storing unit for receiving and storing the program and the extended metadata; a personal program analyzing unit for receiving terminal conditions and user conditions from outside and receiving program conditions from the storing unit, and deciding recourses to be used to provide the adaptive program by using the terminal conditions, the user conditions and the program conditions; and a personal program generating unit for generating and providing the adaptive program by using the resources decided in the personal program analyzing unit.

In accordance with another aspect of the present invention, there is provided a personal terminal apparatus for providing an adaptive program by using extended metadata in a system for providing a digital broadcast program service to diverse kinds of terminals, including: a controlling unit for searching a particular program by receiving the extended metadata, and providing terminal conditions of the personal terminal and user conditions; and a playing unit for receiving and playing the adaptive program.

In accordance with another aspect of the present invention, there is provided a method for providing an adaptive program service to diverse kinds of terminals by using extended metadata, including the steps of: a) providing the broadcast program and the extended metadata; b) storing the program and the extended metadata provided from the step a), and providing an adaptive program that conforms to the utility conditions of a terminal by using resources corresponding to terminal conditions; and c) transmitting the terminal conditions and user conditions and receiving the adaptive program.

In accordance with another aspect of the present invention, there is provided a computer-readable recording medium for recording a program that implements a method for providing an adaptive program service to diverse kinds of terminals by using extended metadata, the method including the steps of: a) providing the broadcast program and the extended metadata; b) storing the program and the extended metadata provided from the step a), and providing an adaptive program that conforms to the utility conditions of a terminal by using resources corresponding to terminal conditions; and c) transmitting the terminal conditions and user conditions and receiving the adaptive program.

### BRIEF DESCRIPTION OF DRAWINGS

The above and other objects and features of the present invention will become apparent from the following description of the preferred embodiments given in conjunction with the accompanying drawings, in which:

FIG. 1 is a diagram showing a structure of the conventional metadata;

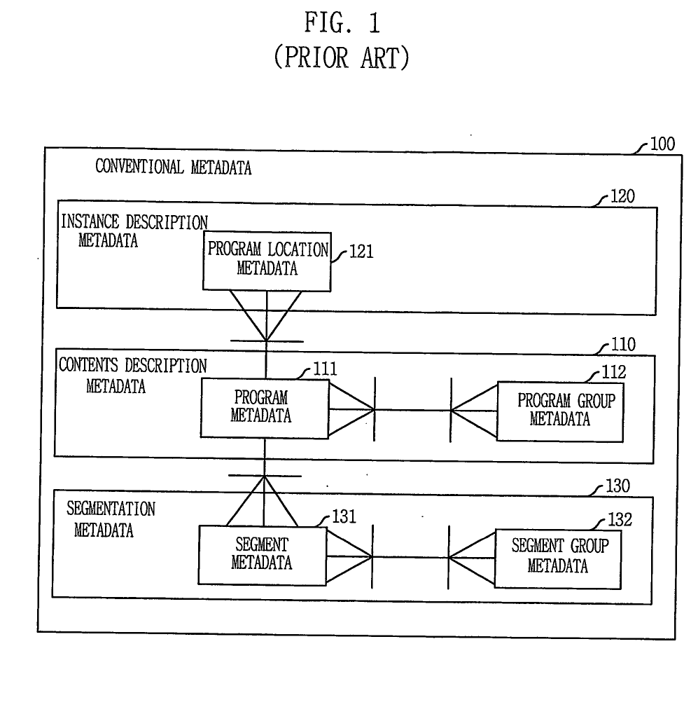

FIG. 2 is a diagram showing a structure of extended metadata in accordance with an embodiment of the present invention;

FIG. 3 is a block diagram describing a personal program service providing system using extended metadata in accordance with an embodiment of the present invention; and

FIG. 4 is a flowchart describing a personal program service providing method using extended metadata in accordance with an embodiment of the present invention.

### BEST MODE FOR CARRYING OUT THE INVENTION

Other objects and aspects of the invention will become apparent from the following description of the embodiments with reference to the accompanying drawings, which is set forth hereinafter. The same reference numeral is given to the same element, although the element appears in different drawings. Preferred embodiments of the present invention will be described herein by referring to the drawings.

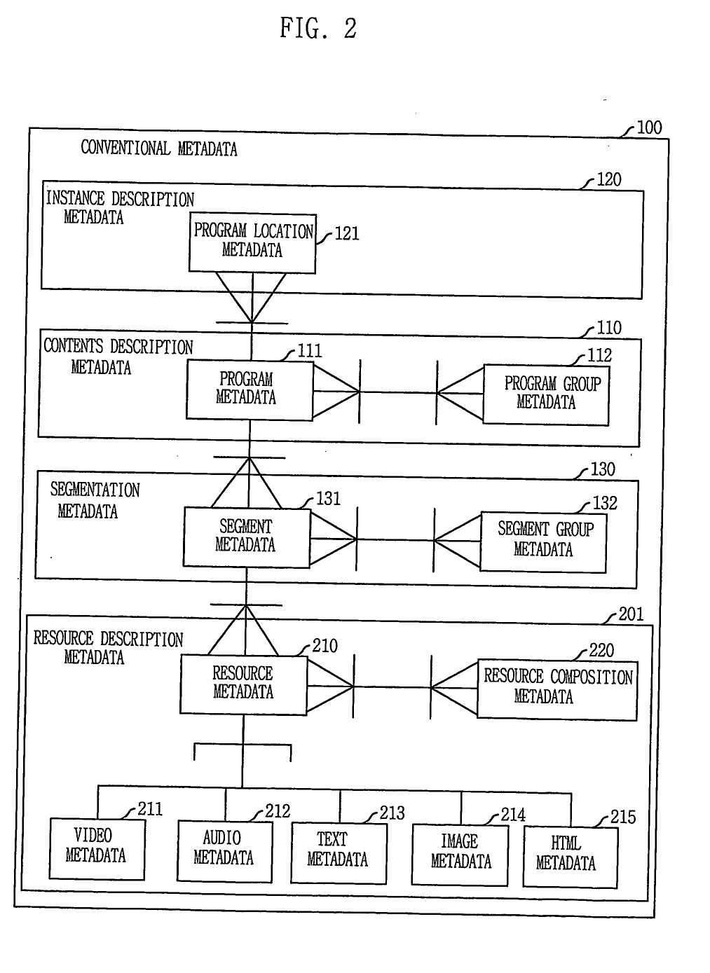

FIG. 2 is a diagram showing a structure of extended metadata in accordance with an embodiment of the present invention. As shown, the metadata of the present invention have a structure in which resource description metadata 201 are added to a conventional metadata structure. Hereafter, the metadata of the present invention including the resource description metadata 201 added to the conventional metadata structure will be referred to as extended metadata 200.

The resource description metadata 201 describe low-ranked composition resources of significant segments constituting a program. The resource description metadata 201 include resource metadata 210 and resource composition metadata 220.

The resource metadata 210 include general description, such as identifier (ID), locator, size of image, and volume, on the lower composition resources of the significant segments constituting the program, e.g., AV object, key frame, key word and related Hyper Text Markup Language (HTML).

The resource composition metadata 220 include information on the environment of a personal terminal, such as a terminal, a program and a user, and information on the type of resources to be used to compose a scene appropriately to the environment.

More specifically, the resource metadata 210 are an abstract type of metadata describing information on each of the individual lower composition resources constituting the significant segments of the program. They include an independent identifier, a Content Reference Identifier (CRID), in a physical location of a resource.

The resource metadata 210 include video metadata 211, audio metadata 212, text metadata 213, image metadata 214, and HTML metadata 215. The video metadata 211 describe video object information of segments described by upper segmentation metadata 130. The video metadata 211 include CRID of the segments, an aspect ratio, a file format, a file volume, a bit rate, a color domain, a starting point of a program and video section information.

The audio metadata 212 describe audio object information of segments described by the upper segmentation metadata 130. The audio metadata 212 include CRID, a file format, a file volume, bit rate, sampling frequency, number of channels, start point of a program, and/or audio section information.

The text metadata 213 describe text object information of the segments described by the upper segmentation metadata 130, such as keywords and synopsis. The text metadata 213 include CRID and a language type.

The image metadata 214 describe image object information of the segments described by the upper segmentation metadata 130. The image metadata 214 include CRID, the aspect ratio of a screen, a file format, a file volume, a bit rate and color domain.

The HTML metadata 215 include Uniform Resource Identifier (URI) of an HTML document related to the segments described by the upper segmentation metadata 130. The URI is information showing a physical directory location that provides an adaptive HTML document suitable for the size of a screen of a personal terminal.

The resource composition metadata 220 include utility conditions of the personal terminal and CRID for resources to be used to compose a scene in conformity to the utility conditions.

That is, the resource composition metadata 220 include condition fields for each personal terminal, e.g., terminal condition field, program condition field, and user condition field, and a field having CRID of resources to be used to compose a scene adaptively to the personal terminal having an environment which is a combination of the fields. The resources considered in the resource composition metadata 220 are confined to the resources described in the resource metadata 210.

A broadcast program and a metadata-consuming scene for each terminal can be expressed by AV objects constituting a scene, temporal/spatial location of the AV objects on the scene and interaction information.

Thus, the scene recomposing process for providing a scene adaptively to a personal terminal in a personal program providing service includes the steps of: a) selecting AV objects for recomposing a scene that are suitable for the personal terminal; b) acquiring description information of the selected AV objects; and c) describing the scene by using a selected scene description language.

To be specific, the scene recomposing process of the present invention uses resource metadata 210 and resource composition metadata 220 and goes through the steps of: a) selecting resources suitable for the personal terminal to recompose a scene by referring to the resource composition metadata 220; b) acquiring description information of the selected resources from the resource metadata 210; and c) describing resources, temporal/spatial locations of the resources, and interaction information by using a selected scene description language.

The scene recomposing method of the present invention separates the information on the resources for composing the scene, i.e., resource information, from the scene description information (which is the temporal/spatial location of the AV objects and interaction information) by using the resource metadata 210 and manages the resource information independently.. Thus, the resource information that is used repeatedly can be prevented from being reproduced unnecessarily, when scenes for diverse personal terminal are provided.

In addition, the complicated process of collecting combinations of terminal conditions which should be performed at the step a) and selecting resources for each combination every time can be simplified by using the resource composition metadata and providing information on the available types of resources for the conditions of each personal terminal.

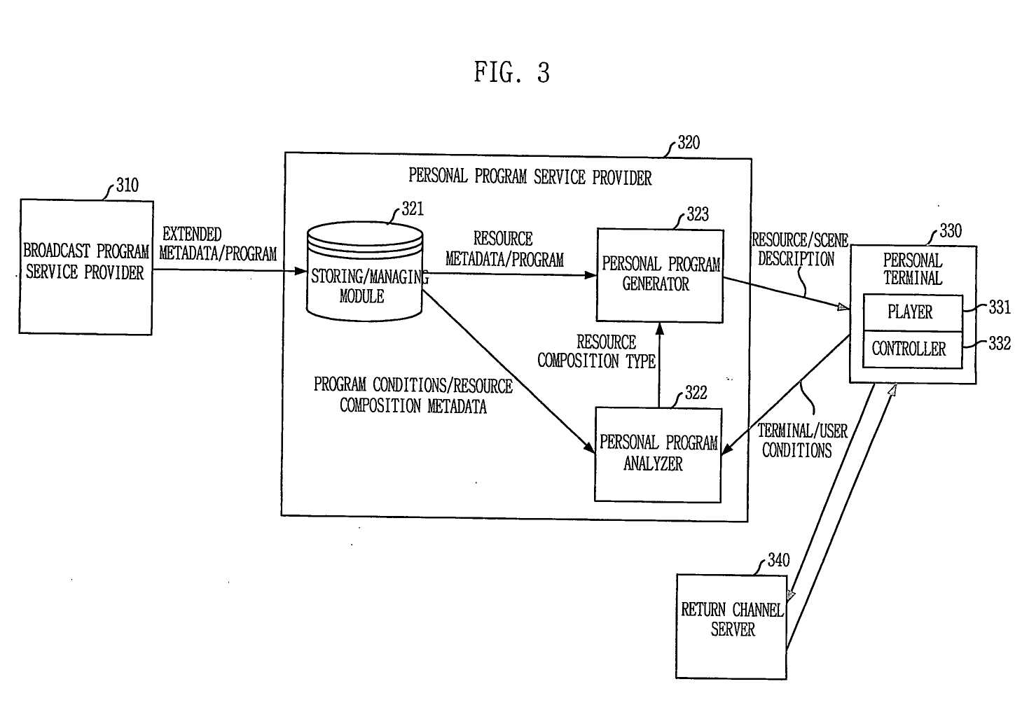

FIG. 3 is a block diagram describing a personal program service providing system using extended metadata in accordance with an embodiment of the present invention. As shown, the personal program service providing system includes a plurality of broadcast program service providers 310, a personal program service provider 320, personal terminals 330 of diverse types, and a return channel server 340.

The personal program service provider 320 receives, stores and manages a broadcast program and extended metadata from a broadcast program service provider 310, and provides the broadcast program and the extended metadata to the personal terminals adaptively.

The personal terminals 330 of diverse types having limited system resources, such as a CPU processing rate, the aspect ratio of a screen, and a storage capacity, are connected with the personal program service provider 320 through a home network (not shown). The return channel server 340 formed outside provides additional materials connected to a particular program.

The personal program service provider 320 is a location-independent system, such as a settop box in charge of transmitting/receiving a broadcasting service and a separate server installed outside.

The broadcast program service provider 310 transmits a broadcast program and extended metadata to the personal program service provider 320. The personal program service provider 320 receives the broadcast program and extended metadata and stores and manages them in a storing/managing module 321. If a personal terminal 330 of a home network requests to watch a high-resolution broadcast program and metadata, an internal personal program analyzer 322 is operated.

The personal program analyzer 322 searches resource composition metadata of the storing/managing module 321 and determines resource composition type, which is a sort of resources to be used to compose a scene adaptively to the personal terminal, by using program conditions of the storing/managing module 321 and terminal and user conditions transmitted from a controller 332 of the personal terminal.

The determined resource composition type is transmitted from the personal program analyzer 322 to a personal program generator 323. Simultaneously, the personal program generator 323 receives resource metadata and program of the resources designated by the resource composition type from the storing/managing module 321. Then, the personal program analyzer 322 acquires information on the resources composing a scene from the resource metadata and generates a scene description document having scene information adapted to the personal terminal by using a scene description language.

The scene description document generated by the personal program service provider 320 and the resources to be used for the newly generated adaptive scene are transmitted to the personal terminal through the home network. Then, the player 331 of the personal terminal 330 parses the scene description document and, by using program resources, displays the adaptive scene to the personal terminal.

Also, a user of the personal terminal 330 who consumes the adaptive scene can request an external return channel server 340 to send a program resource that composes the scene, which is a program-related additional material such as an HTML document, while watching the scene to thereby receive an adaptive HTML document onto a screen of the personal terminal 330.

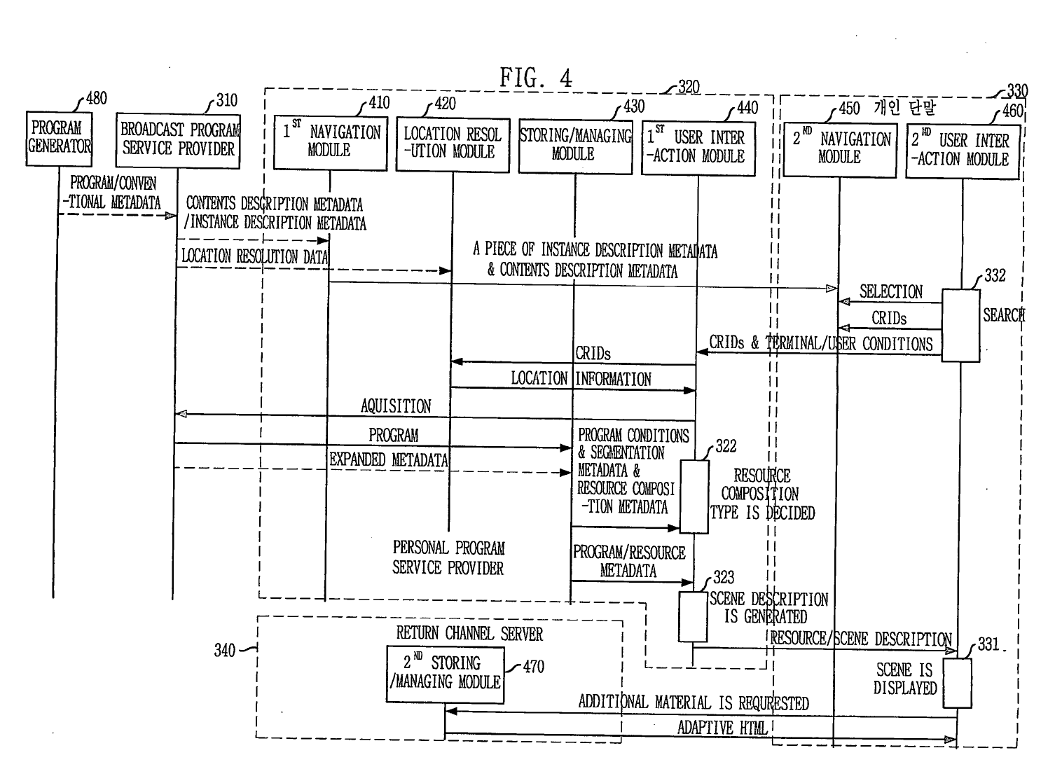

FIG. 4 is a flowchart describing a personal program service providing method using extended metadata in accordance with an embodiment of the present invention. It shows an operation of the adaptive program service providing system. Followings are the flow of the operation.

Generation

The broadcast program service provider receives a new program and conventional metadata describing the program from an external system, a program generator 480. The program generator 480 may include a program producer such as movie studio or an entertainment company and it is an apparatus for generating and transmitting the program and the conventional metadata in the program producer.

Publication

The broadcast program service provider 310 generates extended metadata by generating resource metadata in addition to the conventional metadata.

Also, the broadcast program service provider 310 repacks program and metadata and broadcasts a program, and publishes CRID referring to a program in the early stage of the broadcasting service, instance description metadata, and content description metadata and location resolution data having temporal and physical location information for acquiring a program.

The published CRID, content description metadata and instance description metadata are transmitted to a first navigation module 410 of the personal program service provider 320 and the location resolution data are transmitted to a location resolution module 420 of the personal program service provider 320.

Subsequently, the personal program service provider 320 transmits the content description metadata and a piece of the instance description metadata to a second navigation module 450 of the personal terminal 330 connected through a network.

Search

The second navigation module 450 renders Electronic Program Guide (EPG) by using the content description metadata and instance description metadata, and the controller 332 of a second user interaction module 460 searches the EPG to select a program to be watched.

Selection

If the controller 332 of the second user interaction module 460 selects a desired program in the EPG, the second navigation module 450 informs the CRID of the selected program to the user. Then, the controller 332 transmits the CRID of the selected program and the terminal/user conditions to a first user interaction module 440.

Location

The first user interaction module 440 of the personal program service provider 320 transmits the CRID of the program to the location resolution module 420 and, in return, receives physical locators.

Acquisition

The personal program service provider 320 acquires a program, segmentation metadata of the program, resource metadata and resource composition metadata 220 from the broadcast program service provider 310 by selecting one of the physical locators and stores them in the storing/managing module.

Resource Composition Type Decision

The personal program analyzer 322 of the first user interaction module 440 receives program conditions, program segmentation metadata, and resource composition metadata from the storing/managing module 430.

The personal program analyzer 322 searches the resource composition metadata of the storing/managing module 430 that conform to the program conditions, the user conditions transmitted from the personal terminal 330 at the previous step of selection and, then, it decides a resource composition type, a type of resources to be used to compose a scene adaptive to the personal terminal 330.

Scene Description Generation

The resource composition type, which is decided in the above, is transmitted from the personal program analyzer 322 to the personal program generator 323. At the same time, the personal program generator 323 receives from the storing/managing module 430 program and resource metadata of the resources designating the resource composition type.

Then, the personal program generator 323 generates a scene description document in which a scene adaptive to the personal terminal 330 is described by acquiring information on the resources constituting a scene from the resource metadata and describing the temporal/spatial location and interaction of the resources in a scene description language.

Home Networking

The scene description document generated by the personal program generator 323 of the personal program service provider 320 and the program resources composing the scene are transmitted to the second user interaction module 460 of the personal terminal 330 through the home network.

View

The player 331 of the second user interaction module 460 parses the scene description document and make the user watch the scene, which is a program consuming scene, by using the related program resources and providing the program consuming scene to the second user interaction module 460.

In addition, while watching the scene, the user can request materials related to the scene, for example, an HTML document, to the return channel server 340. Then, a second storing/managing module of the return channel server 340 transmits an adaptive HTML document appropriate for the size of the scene of the personal terminal version.

Finishing

After watching the program on the personal terminal 330, usage history is stored in a consumed program list of the personal terminal 330 and user preference is extracted based on the usage history.

As described above the method of the present invention can be embodied as a program and stored in a computer-readable recording medium, such as CD-ROM, RAM, ROM, floppy disks, hard disks, magneto-optical disks and the like.

As described above, with one scene, the technology of the present invention can provide a multiple number of scenes suitable for a plurality of personal terminals by separating AV objects composing the scene from temporal/spatial location and interaction and managing the AV objects as resource metadata. Therefore, the technology of the present invention can remove the unnecessary process of re-producing resources that are used repeatedly, while bringing in the effect of efficient and consistent information management.

Also, along with information on the sub-resources forming the program, the information on the available type of resources that can be selected according to the conditions is managed as the resource composition metadata. Therefore, the complicated process of selecting resources by combinations of the conditions can be simplified.

Meanwhile, the present invention can manage all combinations of the terminal/program/user conditions of a personal terminal and resources suitable for each combination to provide an adaptive digital broadcasting service for a plurality of terminal environments of a home network by expending a convention metadata structure, and recompose a scene adaptive to each terminal in use effectively by managing the resource-related information separately from temporal/spatial location information.

The technology of the present invention uses an active method that can recompose a broadcast program and a metadata-consuming scene adaptively to each terminal according to a terminal/program/user conditions by using expanded metadata in providing a personal program service, instead of using an inactive method such as a conventional simple program transform and a data dropping which uses data redundancy.

While the present invention has been described with respect to certain preferred embodiments, it will be apparent to those skilled in the art that various changes and modifications may be made without departing from the scope of the invention as defined in the following claims.

What is claimed is:

1. Extended metadata for providing a digital broadcast program service to diverse kinds of terminals, comprising:
segmentation metadata including description information on a significant segment that forms the broadcast program; and
resource description metadata including description information on lower composition resources of the segment in order to provide a broadcast program to the diverse kinds of terminals.

2. The extended metadata as recited in claim 1, wherein the resource description metadata include:
resource metadata including description on general information for the lower composition resources; and
resource composition metadata including information on utility conditions of each terminal, which will be referred to as utility condition information, and information on the type of resources to be used to compose a scene in conformity to the utility conditions, which will be referred to as resource type information.

3. The extended metadata as recited in claim. 2, wherein the general information is separated from temporal/spatial location and interaction information of the resources.

4. The extended metadata as recited in claim 3, wherein the utility condition information of the terminal includes terminal conditions, broadcast program conditions and user conditions.

5. The extended metadata as recited in claim 4, wherein the resource type information includes content reference identifier (CRID) of a resource.

6. The extended metadata as recited in claim 5, wherein the resource metadata describe video entities of segments described by upper segmentation metadata.

7. The extended metadata as recited in claim 6, wherein the video entities include CRID of the segments, aspect ratio of a screen, file format, file size, bit rate, color domain, starting point of a program, and video section information.

8. The extended metadata as recited in claim 7, wherein the resource metadata further include audio metadata describing audio entities of segments described by the upper segmentation metadata.

9. The extended metadata as recited in claim 8, wherein the audio entities include CRID of the segments, file format, file size, bit rate, sampling frequency, number of channels, starting point of a program, and audio section information.

10. The extended metadata as recited in claim 9, wherein the resource metadata further include text metadata describing text entities of the segment described by the upper segmentation metadata.

11. The extended metadata as recited in claim 10, wherein the text entities include CRID of the resource and language type information.

12. The extended metadata as recited in claim 11, wherein the resource metadata further include image metadata describing image entities of the segments described by the upper segmentation metadata.

13. The extended metadata as recited in claim 12, wherein the image entities include CRID of the segments, aspect ratio of a screen, file format, file size, bit rate, and color domain information.

14. The extended metadata as recited in claim 13, wherein the resource metadata further include Uniform Resource Identifier (URI) of a Hyper Text Markup Language (HTML) document related to the segments described by the upper segmentation metadata.

15. A system for providing an adaptive program service by using extended metadata to provide a digital broadcast program service to diverse kinds of terminals, comprising:
a broadcast program service providing means for providing the program and the extended metadata;
a personal program service providing means for storing the program and the extended metadata transmitted from the broadcast program service providing means, and providing an adaptive broadcast program that conforms to utility conditions of a terminal by using resources corresponding to terminal conditions; and
a personal terminal controlling/playing means for transmitting the terminal conditions and user conditions to the personal program service providing means and receiving the adaptive program from the personal program service providing means.

16. The system as recited in claim 15, wherein the personal program service providing means includes:
a storing means for receiving and storing the program and the extended metadata;
a personal program analyzing means for receiving the terminal conditions and the user conditions from the personal terminal controlling/playing means and receiving program conditions from the storing means, and deciding recourses to be used to provide the adaptive broadcast program; and
a personal program generating means for generating the adaptive program by using the resources decided in the personal program analyzing means, and transmitting the adaptive program to the personal terminal controlling/playing means.

17. The system as recited in claim 16, wherein the personal terminal controlling/playing means includes:
a controlling means for searching a particular program by receiving the extended metadata from the personal program service providing means, and transmitting the terminal conditions of the personal terminal and the user conditions to the personal program service providing means; and
a playing means for receiving and playing the adaptive program from the personal program service providing means.

18. The system as recited in claim 17, further including:
an additional material providing means for providing an additional material related to the particular program to the personal terminal controlling/playing means.

19. The system as recited in claim 18, wherein the extended metadata include:
segmentation metadata including description on a significant segment that compose the program; and
resource description metadata including description on lower composition resources of the segments in order to provide the program adaptively to the diverse kinds of terminals.

20. The system as recited in claim 19, wherein the resource description metadata include:
resource metadata describing general information on the lower composition resources; and
resource composition metadata including utility conditions of a terminal and information on the type of resources to be used to compose a scene in conformity to the utility conditions, which will be referred to as resource type information.

21. The system as recited in claim 20, wherein the general information is separated from the temporal/spatial location and interaction information of a resource.

22. The system as recited in claim 21, wherein the utility conditions of the terminal include terminal conditions, program conditions and user conditions.

23. The system as recited in claim 22, wherein the resource type information includes Content Reference Identifier (CRID) of a resource.

24. The system as recited in claim 23, wherein the resource metadata include:
video metadata describing video entities of segments described by upper segmentation metadata;
audio metadata describing audio entities of the segments described by the upper segmentation metadata;
text metadata describing text entities of the segments described by the upper segmentation metadata;
image metadata describing image entities of the segments described by the upper segmentation metadata; and
Uniform Resource Identifier (URI) of a Hyper Text Markup Language (HTML) document related to the segments described by the upper segmentation metadata.

25. The system as recited in claim 24, wherein the resource metadata further include:
the video entities including CRID of the segments, aspect ratio of a screen, file format, file size, bit rate, color domain, starting point of a program, and video section information;
the audio entities including CRID of the segments, file format, file size, bit rate, sampling frequency, number of channels, starting point of a program, and audio section information;
the text entities including CRID of the resource and language type information; and
the image entities including CRID of the segments, aspect ratio of a screen, file format, file size, bit rate, and color domain information.

26. An apparatus for providing a broadcast program service by using extended metadata in a system for providing a digital broadcast program to diverse kinds of terminals, comprising:
a broadcast program providing means for providing the program and the extended metadata.

27. The apparatus as recited in claim 26, wherein the extended metadata include:
segmentation metadata including description on a significant segment that compose the program; and
resource description metadata including description on lower composition resources of the segment in order to provide the program to the diverse kinds of terminals.

28. The apparatus as recited in claim 27, wherein the resource description metadata include:
resource metadata including description on general information for the lower composition resources; and
resource composition metadata including information on utility conditions of each terminal, which will be referred to as utility condition information, and information on the type of resources to be used to compose a scene in conformity to the utility conditions, which will be referred to as resource type information.

29. The apparatus as recited in claim 28, wherein the general information is separated from temporal/spatial location and interaction information of the resources.

30. The apparatus as recited in claim 29, wherein the utility condition information of the terminal includes terminal conditions, broadcast program conditions and user conditions.

31. The apparatus as recited in claim 30, wherein the resource type information includes content reference identifier (CRID) of a resource.

32. The apparatus as recited in claim 31, wherein the resource metadata include:
video metadata describing video entities of segments described by upper segmentation metadata;
audio metadata describing audio entities of the segments described by the upper segmentation metadata;
text metadata describing text entities of the segments described by the upper segmentation metadata;
image metadata describing image entities of the segments described by the upper segmentation metadata; and
Uniform Resource Identifier (URI) of a Hyper Text Markup Language (HTML) document related to the segments described by the upper segmentation metadata.

33. The apparatus as recited in claim 32, wherein the resource metadata further include:
the video entities including CRID of the segments, aspect ratio of a screen, file format, file size, bit rate, color domain, starting point of a program, and video section information;
the audio entities including CRID of the segments, file format, file size, bit rate, sampling frequency, number of channels, starting point of a broadcast program, and audio section information;
the text entities including CRID of the resource and language type information; and
the image entities including CRID of the segments, aspect ratio of a screen, file format, file size, bit rate, and color domain information.

34. A personal program service providing apparatus for providing an adaptive program by using extended metadata in a system for providing a digital broadcast program service to diverse kinds of terminals, comprising:
a storing means for receiving and storing the program and the extended metadata;
a personal program analyzing means for receiving terminal conditions and user conditions from outside and receiving program conditions from the storing means, and deciding recourses to be used to provide the adaptive program by using the terminal conditions, the user conditions and the program conditions; and
a personal program generating means for generating and providing the adaptive program by using the resources decided in the personal program analyzing means.

35. The personal program service providing apparatus as recited in claim 34, wherein the extended metadata include:
segmentation metadata including description information on a significant segment that forms the broadcast program; and
resource description metadata including description information on lower composition resources of the segment in order to provide the program to the diverse kinds of terminals.

36. The personal program service providing apparatus as recited in claim 35, wherein the resource description metadata include:
resource metadata including description on general information for the lower composition resources; and
resource composition metadata including information on utility conditions of each terminal, which will be referred to as utility condition information, and information on the type of resources to be used to compose a scene in conformity to the utility conditions, which will be referred to as resource type information.

37. The personal program service providing apparatus as recited in claim 36, wherein the general information is separated from temporal/spatial location and interaction information of the resources.

38. The personal program service providing apparatus as recited in claim 37, wherein the utility condition information of the terminal includes terminal conditions, broadcast program conditions and user conditions.

39. The personal program service providing apparatus as recited in claim 38, wherein the resource type information includes content reference identifier (CRID) of a resource.

40. The personal program service providing apparatus as recited in claim 39, wherein the resource metadata include:
video metadata describing video entities of segments described by upper segmentation metadata;
audio metadata describing audio entities of the segments described by the upper segmentation metadata;
text metadata describing text entities of the segments described by the upper segmentation metadata;
image metadata describing image entities of the segments described by the upper segmentation metadata; and
Uniform Resource Identifier (URI) of a Hyper Text Markup Language (HTML) document related to the segments described by the upper segmentation metadata.

41. The personal program service providing apparatus as recited in claim 40, wherein the resource metadata further include:
the video entities including CRID of the segments, aspect ratio of a screen, file format, file size, bit rate, color domain, starting point of a program, and video section information;
the audio entities including CRID of the segments, file format, file size, bit rate, sampling frequency, number of channels, starting point of a program, and audio section information;
the text entities including CRID of the resource and language type information; and
the image entities including CRID of the segments, aspect ratio of a screen, file format, file size, bit rate, and color domain information.

42. A personal terminal apparatus for providing an adaptive program by using extended metadata in a system for providing a digital broadcast program service to diverse kinds of terminals, comprising:
a controlling means for searching a particular program by receiving the extended metadata, and providing terminal conditions of the personal terminal and user conditions; and
a playing means for receiving and playing the adaptive program.

43. The personal terminal apparatus as recited in claim 42, wherein the extended metadata include:
segmentation metadata including description on a significant segment that forms the broadcast program; and
resource description metadata including description on lower composition resources of the segment in order to provide the program adaptively to the diverse kinds of terminals.

44. The personal terminal apparatus as recited in claim 43, wherein the resource description metadata include:
resource metadata including description on general information for the lower composition resources; and
resource composition metadata including information on utility conditions of each terminal, which will be referred to as utility condition information, and information on the type of resources to be used to compose a scene in conformity to the utility conditions, which will be referred to as resource type information.

45. The personal terminal apparatus as recited in claim 44, wherein the general information is separated from temporal/spatial location and interaction information of the resources.

46. The personal terminal apparatus as recited in claim 45, wherein the utility condition information of the terminal includes terminal conditions, broadcast program conditions and user conditions.

47. The personal terminal apparatus as recited in claim 46, wherein the resource type information includes content reference identifier (CRID) of a resource.

48. The personal terminal apparatus as recited in claim 47, wherein the resource metadata include:
video metadata describing video entities of segments described by upper segmentation metadata;
audio metadata describing audio entities of the segments described by the upper segmentation metadata;
text metadata describing text entities of the segments described by the upper segmentation metadata;
image metadata describing image entities of the segments described by the upper segmentation metadata; and
Uniform Resource Identifier (URI) of a Hyper Text Markup Language (HTML) document related to the segments described by the upper segmentation metadata.

49. The personal terminal apparatus as recited in claim 48, wherein the resource metadata further include:
the video entities including CRID of the segments, aspect ratio of a screen, file format, file size, bit rate, color domain, starting point of a program, and video section information;
the audio entities including CRID of the segments, file format, file size, bit rate, sampling frequency, number of channels, starting point of a program, and audio section information;
the text entities including CRID of the resource and language type information; and
the image entities including CRID of the segments, aspect ratio of a screen, file format, file size, bit rate, and color domain information.

50. A method for providing an adaptive program service to diverse kinds of terminals by using extended metadata, comprising the steps of:
a) providing the broadcast program and the extended metadata;
b) storing the program and the extended metadata provided from the step a), and providing an adaptive program that conforms to the utility conditions of a terminal by using resources corresponding to terminal conditions; and
c) transmitting the terminal conditions and user conditions and receiving the adaptive program.

51. The method as recited in claim 50, wherein the step b) includes the steps of:
b1) receiving and storing the broadcast program and the extended metadata;
b2) receiving the terminal conditions, the user conditions and program conditions, and deciding recourses to be used to provide the adaptive program by using the terminal conditions, the user conditions and program conditions; and
b3) generating the adaptive program by using the resources decided in the personal program analyzing step, and transmitting the adaptive program to the personal terminal.

52. The method as recited in claim 51, wherein the step c) includes the steps of:
c1) searching a particular program by receiving the extended metadata, and transmitting the terminal conditions of the personal terminal and the user conditions; and
c2) receiving and playing the adaptive program.

53. The method as recited in claim 52, further including a step of:
providing an additional material related to the particular program to the personal terminal.

54. The method as recited in claim 53, wherein the extended metadata include:
segmentation metadata including description on a significant segment that compose the program; and
resource description metadata including description on lower composition resources of the segments in order to provide the program adaptively to the diverse kinds of terminals.

55 . The method as recited in claim 54, wherein the resource description metadata include:
resource metadata describing general information on the lower composition resources; and
resource composition metadata including utility conditions of a terminal and information on the type of resources to be used to compose a scene in conformity to the utility conditions, which will be referred to as resource type information.

56. The method as recited in claim 55, wherein the general information is separated from the temporal/spatial location and interaction information of a resource.

57. The method as recited in claim 56, wherein the utility conditions of the terminal include terminal conditions, program conditions and user conditions.

58. The method as recited in claim 57, wherein the resource type information includes Content Reference Identifier (CRID) of a resource.

59. The method as recited in claim 58, wherein the resource metadata include:
video metadata describing video entities of segments described by upper segmentation metadata;
audio metadata describing audio entities of the segments described by the upper segmentation metadata;
text metadata describing text entities of the segments described by the upper segmentation metadata;
image metadata describing image entities of the segments described by the upper segmentation metadata; and
Uniform Resource Identifier (URI) of a Hyper Text Markup Language (HTML) document related to the segments described by the upper segmentation metadata.

60. The method as recited in claim 59, wherein the resource metadata further include:
the video entities including CRID of the segments, aspect ratio of a screen, file format, file size, bit rate, color domain, starting point of a program, and video section information;
the audio entities including CRID of the segments, file format, file size, bit rate, sampling frequency, number of channels, starting point of a program, and audio section information;
the text entities including CRID of the resource and language type information; and
the image entities including CRID of the segments, aspect ratio of a screen, file format, file size, bit rate, and color domain information.
